(19) United States
(12) Patent Application Publication
(10) Pub. No.: US 2026/0369539 A1
(43) Pub. Date: Nov. 19, 2026

(54) METHOD OF OPERATING AND ION MOBILITY SPECTROMETER AND APPARATUS

(71) Applicant: SMITHS DETECTION-WATFORD LIMITED, Hemel Hempstead (GB)

(72) Inventors: Jonathan R. ATKINSON, Hemel Hempstead (GB); Alastair CLARK, Hemel Hempstead (GB); Paul ARNOLD, Hemel Hempstead (GB)

(21) Appl. No.: 19/477,697

(22) PCT Filed: Mar. 28, 2024
(86) PCT No.: PCT/GB2024/050878

§ 371 Date: Oct. 22, 2025

(30) Foreign Application Priority Data
Apr. 25, 2023 (GB) 2306080.9

(51) Int. Cl. H01J 49/04; H01J 49/00

(52) U.S. Cl. CPC H01J 49/0422; H01J 49/0031

(57) ABSTRACT

An aspect of the disclosure provides a method of operating an ion mobility spectrometer the ion mobility spectrometer comprising an ioniser, a reaction region adjacent the ioniser, a gate and a detector for detecting the arrival of ions, the method comprising: (i) opening the gate for a first ion-cloud-entry-time to allow a first group of sample ions to travel from the reaction region, through the gate, to the detector to provide a first signal; (ii) opening the gate for a second ion-cloud-entry-time to a second group of sample ions to travel from the reaction region, through the gate, to the detector, to provide a second signal wherein, during the second ion-cloud-entry-time, the gate is closed for a shutter time and then reopened; and, the method further comprising (iii) determining a characteristic of the sample ions based on the first signal and the second signal.

### FIELD OF INVENTION

The present invention relates to methods and apparatus for ion mobility spectrometry (IMS), and more particularly to methods and apparatus for improving the ability of IMS devices to discriminate between ions.

### BACKGROUND

IMS can identify material from a sample of interest by ionising the material (e.g., molecules, atoms, and so forth) and measuring the time it takes the resulting ions to travel a known distance under a known electric field. Each ion's time of flight can be measured by a detector, and the time of flight is associated with the ion's mobility. An ion's mobility relates to its mass and geometry. Therefore, by measuring the time of flight of an ion in the detector it is possible to infer an identity for the ion. These times of flight may be displayed graphically or numerically as a spectrum. Other types of spectrometers, such as mass spectrometers analyse ions according to their mass-charge ratio.

The accuracy of identification, and the ability of an ion mobility spectrometer to distinguish between one species and another, is a major issue. A variety of methods have been proposed to improve accuracy. Many such methods demand that a trade-off be made between sensitivity and resolution.

In an IMS cell which is very short the drift time may also be very short. As a result, separating the peaks associated with different compounds of similar mobility can sometimes be difficult because the low resolution of the system results in the two peaks overlapping. Overlapping peaks may be non-distinguishable or may be otherwise ambiguous. One option might be to provide a longer IMS cell, having a longer drift time, to allow more time for ions of similar mobility to separate. There is however a general drive to reduce the size of equipment, particularly to enable equipment to be handheld or wearable so such solutions are undesirable.

### SUMMARY

Aspects and examples of the present disclosure are set out in the claims and aim to address the above-described technical problems and other problems.

An aspect of the disclosure provides a method of operating an ion mobility spectrometer the ion mobility spectrometer comprising an ioniser, a reaction region adjacent the ioniser, a gate and a detector for detecting the arrival of ions. The method comprises:
(i) opening the gate for a first ion-cloud-entry-time to allow a first group of sample ions to travel from the reaction region, through the gate, to the detector to provide a first signal;
(ii) opening the gate for a second ion-cloud-entry-time to a second group of sample ions to travel from the reaction region, through the gate, to the detector, to provide a second signal wherein, during the second ion-cloud-entry-time, the gate is closed for a shutter time and then reopened; and, the method further comprising
(iii) determining a characteristic of the sample ions based on the first signal and the second signal whereby the first signal provides a baseline spectrum and the second signal provides a notch spectrum.

The gate typically separates the ioniser from the detector. For example, it may be provided between a reaction region and a drift region of the ion mobility spectrometer so that to reach the detector ions must travel from the reaction region, through the gate to the drift region. They then travel along the drift region to the detector.

The first group of sample ions and the second group of sample ions may both be generated from the same sample.

The method may comprise performing a plurality of cycles of the steps (i) and (ii) on the same sample to obtain a plurality of said first signals and a plurality of said second signals, wherein the steps (i) and (ii) are interleaved with each other.

The characteristic may be determined based on the plurality of said first signals and the plurality of said second signals.

The method may further comprise obtaining a first sample of gaseous fluid from a flow in an inlet of an ion mobility spectrometer, wherein the sample ions are obtained from the first sample and obtaining a second sample of gaseous fluid from the flow wherein the sample ions are obtained from the second sample.

Determining a characteristic of the ions based on the first signal and the second signal may comprise determining the characteristic based on a difference between the first signal and the second signal.

The first signal may be used as a baseline for the second signal. The first group of sample ions and the second group of sample ions may be modified to generate daughter ions. The first signal and the second signal are provided by the arrival of the daughter ions at the detector. The modifying may comprise applying an RF electric field to the ions.

The RF electric field may be applied during travel of the ions from the reaction region to the detector.

An aspect provides a method of operating an ion mobility spectrometer to identify presence of a substance of interest, the method comprising:
performing a first operation comprising time of flight ion mobility spectrometry to provide an ion mobility signal from a sample; and,
in the event that the ion mobility signal is ambiguous, performing a second operation comprising the method of any preceding claim to identify the presence of the substance of interest based on the baseline spectrum and the notch spectrum.

An aspect provides a method of operating an ion mobility spectrometer, the method comprising:
providing first operation of an ioniser to ionise a sample, after a gate delay, opening the gate for a gate width to allow ions from the sample to pass through the gate, and then closing the gate to prevent other ions from passing through the gate and determining times of flight of the ions from the gate to a detector to provide an ion mobility signal;
providing second operation of an ioniser to ionise the sample, opening the gate for an ion-cloud-entry-time following the second operation of the ioniser to allow a second group of ions from the sample to pass through the gate to reach the detector, wherein the gate is closed for a shutter time during the ion-cloud-entry-time to provide an inverse ion mobility signal;
determining a characteristic of the sample based on the ion mobility signal and the inverse ion mobility signal.

These methods may comprise performing the second operation to obtain the inverse ion mobility signal in the event that the ion mobility signal fulfils a trigger criterion.

The trigger criterion may comprise at least one of:
(a) the ion mobility signal having a peak in a predetermined detection window;
(b) the ion mobility signal having a peak which exceeds a threshold peak width;
(c) the ion mobility signal providing an ambiguous identification of a candidate substance.

The gate may be opened for a further ion-cloud-entry-time to allow a further group of sample ions to travel from the reaction region, through the gate, to the detector to provide a baseline signal for the inverse ion mobility signal, wherein determining the characteristic of the sample is further based on the baseline signal.

An aspect of the disclosure provides ion mobility spectrometer, the ion mobility spectrometer comprising an ioniser, a gate, a detector, and a controller arranged to control the ioniser and the gate and configured to control the ion mobility spectrometer to perform any one or more of the methods described or claimed herein.

The gate typically separates the ioniser from the detector. For example, it may be provided between a reaction region and a drift region of the ion mobility spectrometer so that to reach the detector ions must travel from the reaction region, through the gate to the drift region. They then travel along the drift region to the detector.

An aspect of the disclosure provides a computer program product configured to program a controller of an ion mobility spectrometer to perform any of the methods described or claimed herein. The controller may be arranged to control the ioniser and the gate of the ion mobility spectrometer. It may further be arranged to control the ion modifier and/or a pressure pulser for taking samples from the inlet.

Embodiments of the disclosure may aim to reduce peak broadening in IMS signals. This has particular application to drift tube IMS systems. As an ion packet travels down the drift tube, the ion packet may become wider (spread out in the drift direction) due to the ions repelling one another. This may be referred to as a Coulomb broadening effect (as it is due to mutual repulsion of ions within an ion peak). Diffusion effects also tend to broaden peaks in conventional IMS. Where such peak broadening effects become particularly bad, peaks which are close to one another can appear as a single broad peak or it can become ambiguous whether one or two or more separate peaks are present but overlapping. The effective drift-time resolution is also reduced.

Embodiments of the disclosure may provide systems and methods for performing ion mobility spectrometry in which diffusion effects and Coulomb effects are used to improve rather than to degrade the ability of the spectrometer accurately to resolve the drift time of ions.

### BRIEF DESCRIPTION OF DRAWINGS

Embodiments of the disclosure will now be described in detail with reference to the accompanying drawings, in which:

FIG. 1 shows an ion mobility spectrometer;

FIG. 2 comprises a series of plots of illustrative timing diagrams for operation of an ion mobility spectrometer such as that illustrated in FIG. 1;

FIG. 3 illustrates detection signals obtained by operating an ion mobility spectrometer according to the methods of the present disclosure, including:
FIG. 3A, which shows a “baseline” detection signal obtained by holding the gate open for the entire ion-cloud-entry-time;
FIG. 3B, which shows a “notch” detection signal obtained by holding the gate open for the ion-cloud-entry-time other than for a shutter interval; and
FIG. 3C which shows the difference between the baseline and notch signals.

FIG. 4 comprises a flow chart illustrating methods of operating an ion mobility spectrometer.

In the drawings like reference numerals are used to indicate like elements.

### SPECIFIC DESCRIPTION

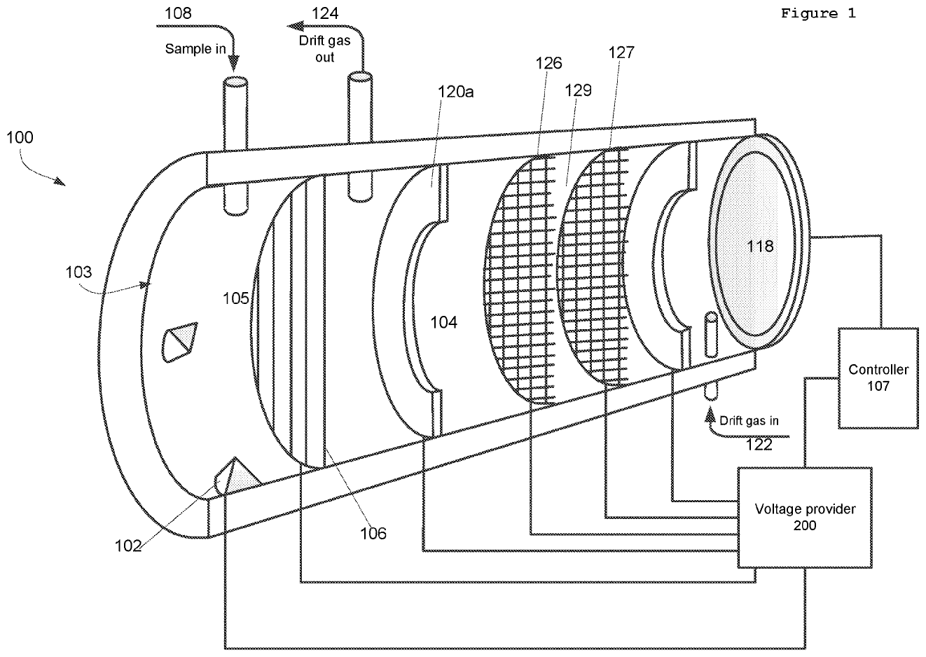

FIG. 1 is an illustration of a part section through an ion mobility spectrometer (IMS) 100. The spectrometer illustrated in FIG. 1 includes an ioniser 102 that is separated from a drift chamber 104 by a gate 106. The gate 106 can control passage of ions from the ioniser 102 into the drift chamber 104.

A controller 107 is connected to operate the ioniser and the gate 106. In the example illustrated in FIG. 1, the drift chamber 104 lies between the ioniser 102 and a detector 118, so that ions can reach the detector 118 by traversing the drift chamber 104.

The controller 107 is configured to operate the IMS 100 to generate an inverse-gate IMS signal by holding the gate open after a sample has been ionised and then briefly closing the gate 106 for a period referred to herein as a “shutter time” (explained below) and reopening it while the cloud of ions generated from the sample is still travelling through the gate 106. This brief closing and then reopening of the gate 106 during transit of the ion cloud through the gate creates a gap in that ion cloud. The ion cloud, with that gap, then travels down the drift chamber to the detector 118. The arrival of those ions at the detector 118 generates a signal indicating their time of arrival. The gap is reflected in that signal as a “notch” or dip in the ion count.

The controller 107 also operates the IMS to generate a “baseline” IMS signal. It does this by operating the ioniser 102 to ionise the sample and holding the gate open without closing it while the cloud of ions is travelling through it. In other words, it ionises the sample and allows all the ions to travel to the detector while the gate is just kept open. The same sample may be used for both the inverse-gate IMS signal and the baseline.

This provides two different detection signals—one so-called inverse-gate IMS signal in which a “notch” has been imposed in the ion cloud by the closing and reopening of the gate 106 during transit of the ion cloud. The other is a baseline signal, which characterises the ion cloud itself.

The difference between the notch signal and the baseline signal can be used to provide an inverse-gate IMS spectrum in which the effect of using a non-continuous ion source is accounted for by the baseline signal.

As illustrated, the IMS 100 includes an inlet 108 for enabling material to be introduced from a sample of interest to the ioniser 102. This may be a pinhole inlet or a membrane inlet arranged for taking samples from a flow of air. A pressure pulser (not shown) may be provided to allow such samples to be taken. Other methods of introducing sample through the inlet 108 may also be used. The inlet 108 is arranged to introduce the sample to a reaction region 105 of an ionisation chamber 103. The ioniser 102 is disposed in the ionisation chamber and typically comprises an ioniser configured to be selectively operated to generate ions for a controlled interval—e.g., for intermittent as opposed to the continuous operation. Examples of such an ioniser 102 include corona point sources and dielectric barrier discharge (DBD) ion sources. The ioniser 102 may be operated to generate ions, which may be referred to as reactant ions, which can be mixed with the sample in the reaction region 105 to ionise the sample. Such a process may be referred to as indirect ionisation.

The controller 107 may be configured to control operation of the pressure pulser, the ioniser 102, and the gate 106. For example, it may be coupled to a voltage provider 200, such as a digitally controlled voltage source e. g. a DAC, arranged to provide control voltages to these components. The controller 107 may similarly be arranged to control an ion modifier 126, 127 (described below). For example, as shown in FIG. 1 a voltage provider 200 may be coupled to be controlled by the controller 107. The voltage provider 200 may also be coupled to provide voltages to the ioniser 102 to enable material from a sample to be ionised. In an embodiment the voltage provider 200 is coupled to the gate electrode 106 to control the passage of ions from the ionisation chamber into the drift chamber 104.

The voltage provider 200 may also be coupled to the drift electrodes 120a, 120b for providing a voltage profile for moving ions from the ioniser 102 toward the detector 118. It will be appreciated in the context of the present disclosure that the drift chamber 104 may comprise a series of such drift electrodes 120a, 120b for applying a voltage profile along the drift chamber 104 to move ions from the ioniser 102 along the drift chamber 104 toward the detector 118.

The IMS 100 may be configured to provide a flow of drift gas in a direction generally opposite to an ion's path of travel to the detector 118. For example, the drift gas can flow from adjacent the detector 118 toward the gate 106. As illustrated, a drift gas inlet 122 and drift gas outlet 124 can be used to pass drift gas through the drift chamber. Example drift gases include, but are not limited to, nitrogen, helium, air, air that is re-circulated (e.g., air that is cleaned and/or dried) and so forth.

The detector 118 may be coupled to provide a signal to the controller 107. Current flow from the detector 118 can be used by the controller 107 to infer that ions have reached the detector 118. Examples of detectors include Faraday cups and other types of ion detector configured to provide a signal indicating that ions have arrived at the detector 118. For example, the detector may comprise a conductive electrode which may be charged to catch ions.

Electrodes 120a, 120b, may be arranged to guide ions toward the detector 118, for example the drift electrodes 120a, 120b may comprise rings which may be arranged around the drift chamber 104 to focus ions onto the detector 118. Although the example of FIG. 1 includes only two drift electrodes 120a, 120b, in some examples a plurality of electrodes may be used, or a single electrode may be used in combination with the detector 118 to apply an electric field to guide ions toward the detector 118.

An ion modifier 126, 127 can be arranged between the ioniser 102 and the detector 118 in the path of ions travelling from the ioniser 102 toward the detector 118. The ion modifier may comprise two electrodes 126, 127 each spanning the drift chamber 104 across the path of the ions. Ions travelling through the region between the two electrodes can be subjected to an alternating electric field, such as an RF field by the application of RF voltage to those electrodes.

The ion modifier electrodes 126, 127 can be spaced apart from the gate electrode 106. As illustrated, the ion modifier electrodes 126, 127 may be arranged in the drift chamber, between the gate electrode and the detector. In an embodiment the ion modifier electrodes may be arranged in the ionisation chamber, for example between the inlet 108 and the gate 106. Each of the ion modifier electrodes 126, 127 can comprise an array of conductors arranged across the drift chamber. The ion modifier electrodes 126, 127 may be spaced apart from each other in the drift direction-e.g. the direction along the length of the drift chamber. As illustrated, the conductors of each ion modifier electrode 126, 127 may have gaps between them such that ions can pass through each electrode by travelling through the gaps. In one example ions pass through the gaps between the conductors of the electrode 126, into a region 129 between the electrodes 126, 127, and out of the region through the gaps between the conductors of the electrode 127. While the ions are in the region between the electrodes 126, 127 they can be subjected to an alternating, RF, electric field. This RF electric field may be configured to fragment or to modify the ions in the region 129 between the electrodes 126, 127.

In operation, the controller operates the pressure pulser to obtain a sample of material into the ionisation chamber 103. The controller 107 and voltage provider 200 then provide electrical energy to the ioniser 102 to generate a cloud of ions by ionising the sample. After ionisation of the sample, the controller 107 holds the ion gate 106 open for an ion-cloud-entry-time to allow the cloud of sample ions to enter the drift region 104. The detector 118 provides a baseline signal to the controller 107 representing the ion count associated with the arrival, at the detector, of this ion cloud.

To generate the “notch” spectrum, another cloud of ions is generated as for the baseline signal. The gate 106 is held open for the same ion-cloud-entry-time after operation of the ioniser. However, the gate is closed and then reopened during the ion-cloud-entry-time —the interval for which the shutter is closed may be referred to as the shutter time. This causes a gap in the ion cloud, which may otherwise extend from the reaction region to the detector. The spatial width of that gap generally corresponds to the shutter time and varies according to the speed of the ions. The gap in the ion cloud travels towards the collector and is detected as an “inverse peak” or notch in the IMS spectrum. If a single species of ion is present the gap which arrives at the detector may essentially correspond to the gap created by the gate. On the other hand, if there are ion species present having different mobilities from each other, the shape of the gap will change as the cloud travels down the drift chamber in accordance with these different mobilities. For example, multiple inverse peaks (“notches”) may be formed in the signal by the effect of these different mobilities on the gap created by the gate 106.

The benefit of this approach is that Coulomb effects and diffusion effects work to keep the inverse peaks narrow rather than to widen them as it does in normal IMS. However, the use of a pulsed ion source means that it may not be possible to recover an accurate inverse-gate IMS spectrum from the “notched” detector signal. Embodiments of the disclosure address this problem by obtaining the baseline signal, obtained from the ion cloud without the “shutter time” gap and subtracting the baseline signal from the notch signal.

The controller may be configured to operate the ion modifier to fragment or modify ions. Typically, if the ion modifier is used, the same operation of the modifier may be used during both the “notch” and “baseline” operations of the device. In addition, typically the same sample is used for both operations but in some embodiments a separate sample may be used for each of the two operations. Generally, those two separate samples would be obtained from the same flow of air.

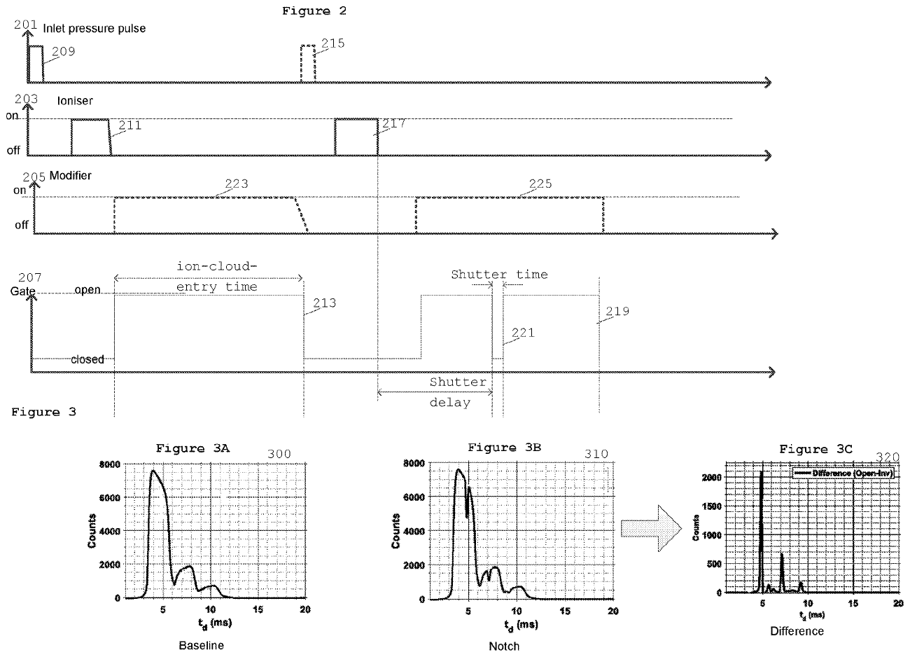

A method of operating the above apparatus will now be described in greater detail with reference to FIG. 2.

FIG. 2 shows a series of timing diagrams in which the horizontal axis is time and the vertical axis indicates activation or state of a component of the IMS apparatus 100.

The first timing diagram 201 shows the operation of the inlet 108 to obtain a sample of gaseous fluid and to provide it to the ioniser 102, such as by operation of a pressure pulser.

The second timing diagram 203 indicates the timing of operation of the ioniser 102 to ionise the sample.

The third timing diagram 205 indicates the, optional, operation of an ion modifier 126, 127 to modify or fragment the ions.

The fourth timing diagram 207 indicates operation of the gate 106 to open and to close to admit ions to the drift chamber 104.

As illustrated, first, the pressure pulser 209 is operated to draw a sample of gaseous fluid to the ioniser 102. The ioniser 102 is then provided with a pulse 211 of electrical energy to provide reactant ions. The reactant ions mix with the sample in the reaction region 105 to generate a cloud of sample ions.

After operation 211 of the ioniser, the ion gate 106 is then opened and held open 213 for an ion-cloud-entry time. This ion-cloud-entry time may be long enough to allow substantially all of the ion cloud to pass from the reaction region 105 through the gate 106 towards the detector 118.

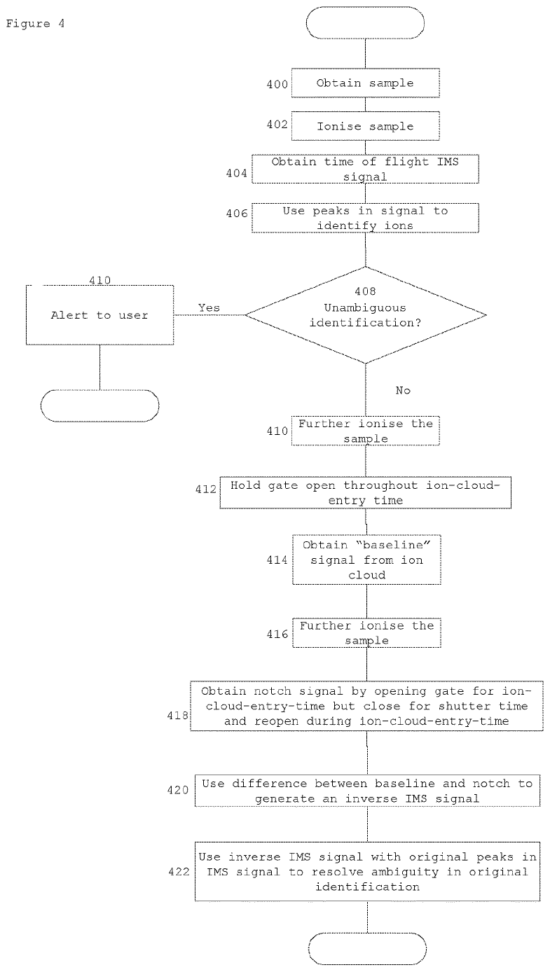

In response to the arrival of ions in the ion cloud at the detector 118, the detector 118 provides a signal 300 to the controller 107. As illustrated in FIG. 3B the signal 300 may represent the ion count arriving at the detector 118 as a function of time. The signal obtained by keeping the gate open and allowing substantially all of the ion cloud to pass through it, in effect, produces a very rough or low resolution IMS spectrum—such as might be obtained by using a very long gate width. This signal characterises the ion cloud as a whole in the sense that different ion species in the cloud having different mobilities will arrive at the detector at different times after operation of the ioniser and the opening of the gate but the timing resolution will be very low because there is no constraint on where in the reaction region the ions start travelling from. They need not be immediately adjacent the gate as in standard time-of-flight IMS.

The pressure pulser may then be operated 215 again to obtain a further sample through the inlet but this is optional because the remains of the previous sample may simply be used again. The ioniser 102 is then operated 217 to generate a new cloud of ions and the gate 106 is then opened 219 for the ion-cloud-entry time. The ion-cloud-entry time used is the same as for the baseline but, during this time, while the ion cloud is still travelling through the ion gate, the ion gate is closed and then reopened 221 again to create a gap in the ion cloud. Typically, the time (the shutter time) for which the ion gate is closed during the ion-cloud-entry time corresponds to the gate width in a conventional IMS system. In some embodiments longer shutter times may be used so as to increase the signal to noise ratio, SNR. The Coulomb repulsion effect and diffusion effects may cause a narrowing of the “notch” in the ion cloud and so may permit shutter times to be used that are longer than gate widths in conventional IMS systems. Generally, the time period between the operation of the ioniser and the closing of the gate, which may be referred to as a shutter delay, is chosen to correspond to the gate delay in a conventional IMS system. For example, it may be selected based on the transit time of ion species of interest from the ioniser to the ion gate (e.g., so the shutter time takes place during transit of ions of interest through the gate).

After transit through the gate, the ion cloud then travels along the drift chamber towards the detector. Different ion species in the cloud having different mobilities will take different amounts of time to arrive at the detector. The gap in the ion cloud caused by closing the gate for the shutter time will also travel down the drift region at a velocity determined by the mobility of the ions. The gap will split into multiple gaps if ions of differing mobility are present in the IMS cell. After each gap arrives at the collector, the ion current at the detector will return to a level corresponding to the “baseline” cloud. As illustrated in FIG. 3B the result is a signal 310 which corresponds to the “baseline” but with notches (reductions in ion count).

The controller 107 then determines the difference between the detection signal obtained from the “baseline” cloud (ion gate open throughout) and the signal obtained from closing the ion gate during the ion-cloud-entry time. As illustrated in FIG. 3C, this provides an inverse ion spectrum 320 in which Coulomb repulsion effects and diffusional broadening do not broaden the peaks significantly. Another advantage of such an approach is that, unlike standard inverse-gate IMS systems, there is no need to use a continuous ion source. This may provide increased component life and reduce degradation of the detector (e. g., due to accretion of material on the collector electrode).

The cloud of sample ions which is used to generate the baseline and the cloud of sample ions which is used to generate the notch may both be generated from the same sample of gaseous fluid but by separate (usually successive) operations of the ioniser. Alternatively, the cloud of sample ions which is used to generate the baseline and the cloud of sample ions which is used to generate the notch may each be generated a different sample taken from a flow of air through the inlet.

Optionally, RF electrical energy may be applied 223, 225 to the ion cloud to fragment or to modify the ions. For example this may be done using, electrodes 126, 127 or using the electrodes of the ion gate which may be spaced apart from each other in the drift direction. If such ion modification is used, identical modification may be applied to both the baseline ion cloud and the notch ion cloud.

The same ion-cloud-entry-time may be used both for the baseline 213 and for the notch 219. The ion-cloud-entry-time may be selected SO that substantially all ions generated from the sample by operation of the ioniser are able to move through the gate into the drift region.

The ion modifier is optional. It is not necessary to perform ion modification at all, and in some embodiments it is possible to perform ion modification without a separate ion modifier structure. For example, the two electrodes of the ion gate may also be operated to provide ion modification. To do this an RF voltage may be applied between the electrodes of the ion shutter during the ion-group-transit time while the gate is held open. This may allow the gate to provide the functionality of the ion modifier without the need to provide the electrodes 126, 127. Other ways of modifying or fragmenting the ions may also be used. For example other methods of raising the effective temperature of the ions such as by application of heat energy or by other methods of subjecting the ions to RF electric field.

It will be appreciated that the foregoing embodiments of the present disclosure provide a way to generate an inverse-gate IMS signal using a pulsed ionisation source.

Examples of such methods may comprise:
(i) providing a first operation of an ioniser to generate sample ions;
(ii) opening the gate for a predetermined time interval following the first operation of the ioniser to allow a first group of the sample ions to pass through the gate;
(iii) detecting the first group at the detector to provide a first signal;
(iv) providing a second operation of the ioniser to generate further sample ions;
(v) opening the gate for the predetermined time interval following the second operation of the ioniser to allow a second group of the further sample ions to pass through the gate to reach the detector,
(vi) closing the gate for a shutter time during the predetermined time interval following the second operation of the ioniser, wherein the gate is reopened for a remainder of the predetermined time interval following the shutter time;
(vii) detecting the second group at the detector to provide a second signal; and,
(viii) determining a characteristic of the ions based on the first signal and the second signal.

Determining the characteristic may comprise determining the difference between the first signal and the second signal. This difference may provide an inverse-gate IMS signal. The inverse-gate IMS signal may comprise peaks indicating the mobilities of ion species in the ion cloud.

The predetermined time interval, or ion-cloud-entry-time as it is also referred to herein, may be defined by a gate delay, the gate delay being a time delay between operation of the ioniser and opening of the gate, and a gate width, the gate width being the length of time for which the gate is held open following the gate delay. The shutter time, for which the gate is closed and then reopened, takes place during the ion-cloud-entry-time.

It will be appreciated in the context of the present disclosure that the notch and baseline signals may be acquired in any sequence. For example, the baseline signal may be acquired first followed by the notch spectrum and vice versa.

These and other methods of the disclosure may be employed in a variety of ways. One example is illustrated using the flow chart of FIG. 4.

FIG. 4 is a flow chart illustrating a method of operating an ion mobility spectrometer such as the spectrometers described with reference to FIGS. 1 to 4. In this method, the inverse-gate IMS signal of the present disclosure is used to resolve ambiguity in an IMS signal obtained using a conventional time-of-flight, drift tube, IMS.

First a sample is drawn 400 into the ionisation chamber and the ioniser 102 is operated 402 to generate reactant ions, which are mixed with the sample in the reaction region.

The controller 107 then waits for a gate delay time following the operation of the ioniser, and then opens the gate 106 for a gate width time to allow a packet of ions to enter the drift chamber. The packet of ions the travels down the drift chamber 104 and separates according to the mobilities of the ion species in that packet of ions. The times of arrival of the ions at the detector 118 generate 404 an ion count signal, which may also be referred to as a spectrum. The presence of peaks in this signal in particular detection intervals, which may be referred to as windows, can be used to identify 406 the presence of a substance of interest. This or any other appropriate time of flight IMS method may be used to generate this initial identification signal.

The controller 107 then determines 408 whether the signal unambiguously identifies a substance of interest for example whether a supra-threshold peak (or peaks) is (are) detected in a window (or windows) associated with a substance of interest. In the event that the signal identifies a substance unambiguously, a signal indicating the presence of the identified substance may be provided 410 to a user. Alternatively, if the signal is ambiguous, the controller 107 may cause the IMS cell to perform a pulsed-ionisation inverse-gate IMS method such as those described above with reference to FIG. 1 to 4. As described above, that method may proceed as follows.

The ioniser 102 is operated 410 to generate a cloud of ions by further ionising the sample. The controller 107 holds 412 the ion gate 106 open for an ion-cloud-entry-time to allow the cloud of sample ions to enter the drift region 104. The detector 118 provides 414 a baseline signal to the controller 107 representing the ion count associated with the arrival, at the detector, of this ion cloud.

The ioniser 102 is then operated again 416 to generate a further cloud of ions from the sample. The gate 106 is held open for the same ion-cloud-entry-time after operation of the ioniser and the gate is closed for a shutter time and then reopened during the ion-cloud-entry-time to provide a gap in the ion cloud and a “notch” signal is generated 418 from arrival at the detector 118 of the ion cloud.

The controller 107 then uses the baseline signal and the notch signal to resolve the ambiguity in the original spectrum (e.g. that which was generated at step 406). For example, the controller may determine the difference between the baseline and the notch to generate 420 an inverse-gate IMS signal as illustrated in FIG. 3C. The controller 107 may determine 422 whether the substance of interest is present in the sample based on this inverse signal—for example by comparing peaks in the inverse signal with corresponding detection windows. The controller 107 may also use the original IMS signal (obtained at 406) to determine the presence of the substance.

It will be appreciated in the context of the present disclosure that the above method may be performed by successive ionisation of the same sample, as described. Alternatively, one or more of the original IMS signal, the notch signal, and the baseline signal may be obtained using different samples. The sequence of operation may also be changed—for example the inverse-gate IMS steps (410 to 420) may be performed first and then the conventional time-of-flight ion mobility method may be used to resolve ambiguity in the inverse signal.

Ion modification may also be used in this method as described above.

The ion-cloud-entry-time may be selected to be long enough to allow substantially all of the slowest ion species of the cloud to pass through the gate and so will typically be longer than the gate delay used in a conventional IMS system.

The gate may be opened to begin the ion-cloud-entry-time before operation of the ioniser to ionise the sample, or concurrently with (e. g., during) operation of the ioniser, or after operation of the ioniser has finished. In some embodiments, the voltage of at least one gate of the electrode may be cycled after operation of the ioniser has completed to prevent latching of the gate due to effects caused by the ioniser.

The shutter time, for which the gate is shut during the ion-cloud-entry-time, typically lasts for a period comparable to (e.g., equal to) a gate width in a conventional IMS system. The shutter delay, the period between operation of the ioniser and the closing of the shutter for the shutter period, is typically selected based on the time taken for ion species of interest to reach the gate from the ioniser.

The apparatus of the present disclosure and methods may be used with any type of sampling inlet—membranes and pinholes have been mentioned but according to circumstance any kind of inlet suitable for taking a sample of gaseous fluid and providing it to the ioniser. Other examples include capillary inlets and electrospray inlets and other types of inlet.

The apparatus described herein is shown as including an ion modifier, but this is optional. In some embodiments an ion modifier is not present at all. In other embodiments, ion modification may be used but without providing a separate ion modifier structure. For example, the electrodes of the ion gate may be operated as an ion modifier (e.g., to modify or fragment ions as they travel through the gate).

Any feature of any one of the examples disclosed herein may be combined with any selected features of any of the other examples described herein. For example, features of methods may be implemented in suitably configured hardware, and the configuration of the specific hardware described herein may be employed in methods implemented using other hardware.

It will be appreciated from the discussion above that the embodiments shown in the Figures are merely exemplary, and include features which may be generalised, removed or replaced as described herein and as set out in the claims. With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

In some examples the functionality of the controller 107 may be provided by a general-purpose processor, which may be configured to perform a method according to any one of those described herein. In some examples the controller 107 may comprise digital logic, such as field programmable gate arrays, FPGA, application specific integrated circuits, ASIC, a digital signal processor, DSP, or by any other appropriate hardware. In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein. The controller 107 may comprise an analogue control circuit which provides at least a part of this control functionality. An embodiment provides an analogue control circuit configured to perform any one or more of the methods described herein.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of operating an ion mobility spectrometer the ion mobility spectrometer comprising an ioniser, a reaction region adjacent the ioniser, a gate and a detector for detecting the arrival of ions, the method comprising:
(i) opening the gate for a first ion-cloud-entry-time to allow a first group of sample ions to travel from the reaction region, through the gate, to the detector to provide a first signal;
(ii) opening the gate for a second ion-cloud-entry-time to a second group of sample ions to travel from the reaction region, through the gate, to the detector, to provide a second signal wherein, during the second ion-cloud-entry-time, the gate is closed for a shutter time and then reopened; and, the method further comprising
(iii) determining a characteristic of the sample ions based on the first signal and the second signal.

2. The method of claim 1 wherein the first group of sample ions and the second group of sample ions are both generated from the same sample.

3. The method of claim 2 comprising performing a plurality of cycles of the steps (i) and (ii) on the same sample to obtain a plurality of said first signals and a plurality of said second signals, wherein the steps (i) and (ii) are interleaved with each other.

4. The method of claim 3 wherein the characteristic is determined based on the plurality of said first signals and the plurality of said second signals.

5. The method of claim 1 further comprising obtaining a first sample of gaseous fluid from a flow in an inlet of an ion mobility spectrometer, wherein the first group of sample ions are obtained from the first sample and obtaining a second sample of gaseous fluid from the flow wherein the second group of sample ions are obtained from the second sample.

6. The method of any preceding claim wherein determining a characteristic of the ions based on the first signal and the second signal comprises determining the characteristic based on a difference between the first signal and the second signal, for example by using the first signal as a baseline for the second signal.

7. The method of any preceding further comprising modifying the first group of sample ions and the second group of sample ions to generate daughter ions, wherein the first signal and the second signal are provided by the arrival of the daughter ions at the detector.

8. The method of claim 7 wherein said modifying comprises applying an RF electric field to the ions.

9. The method of claim 8 wherein the RF electric field is applied during travel of the ions from the reaction region to the detector.

10. A method of operating an ion mobility spectrometer to identify presence of a substance of interest, the method comprising:
performing a first operation comprising time of flight ion mobility spectrometry to provide an ion mobility signal from a sample; and,
in the event that the ion mobility signal is ambiguous, performing a second operation comprising the method of any preceding claim whereby the first signal provides a baseline spectrum and the second signal provides a notch spectrum, the method comprising identifying the presence of the substance of interest based on the baseline spectrum and the notch spectrum.

11. A method of operating an ion mobility spectrometer, the method comprising:
providing first operation of an ioniser to ionise a sample, after a gate delay, opening the gate for a gate width to allow ions from the sample to pass through the gate, and then closing the gate to prevent other ions from passing through the gate and determining times of flight of the ions from the gate to a detector to provide an ion mobility signal;
providing second operation of an ioniser to ionise the sample, opening the gate for an ion-cloud-entry-time following the second operation of the ioniser to allow a second group of ions from the sample to pass through the gate to reach the detector, wherein the gate is closed for a shutter time during the ion-cloud-entry-time to provide an inverse ion mobility signal;
determining a characteristic of the sample based on the ion mobility signal and the inverse ion mobility signal.

12. The method of claim 10 or 11 comprising performing the second operation to obtain the inverse ion mobility signal in the event that the ion mobility signal fulfils a trigger criterion.

13. The method of claim 12 wherein the trigger criterion comprises at least one of:
(a) the ion mobility signal having a peak in a predetermined detection window;
(b) the ion mobility signal having a peak which exceeds a threshold peak width;
(c) the ion mobility signal providing an ambiguous identification of a candidate substance.

14. The method of any of claims 11 to 13 as dependent upon claim 11 wherein the method comprises opening the gate for a further ion-cloud-entry-time to allow a further group of sample ions to travel from the reaction region, through the gate, to the detector to provide a baseline signal for the inverse ion mobility signal, wherein determining the characteristic of the sample is further based on the baseline signal.

15. An ion mobility spectrometer, the ion mobility spectrometer comprising an ioniser, a gate, and a controller arranged to control the ioniser and the gate and configured to control the ion mobility spectrometer to perform the method of any preceding claim.

16. A computer program product configured to program a controller of an ion mobility spectrometer to perform the method of any preceding claim, for example wherein the controller is arranged to control an ioniser and a gate of the ion mobility spectrometer.
